(19) United States
(12) Patent Application Publication
(10) Pub. No.: US 2009/0081404 A1
(43) Pub. Date: Mar. 26, 2009

(54) Bucking chute safety pad

(76) Inventor: James P. Liles, Smithfield, UT (US)

Correspondence Address: James P. Liles, 242 S 300 W, Smithfield, UT, 84335, US

(21) Appl. No.: 12/283,517

(22) Filed: Sep. 12, 2008

Related U.S. Application Data
(60) Provisional application No. 60/974,202, filed on Sep. 21, 2007.

(51) Int. Cl. B32B 3/00

(52) U.S. Cl. 428/71

(57) ABSTRACT

The present embodiment 10 provides a safety device for use with rodeo type bucking chutes as a means of reducing serious injuries to the participant, (which are common to the sport of bull riding and bronc riding) while preparing to mount livestock during exhibitions and competitions. The device comprises of a pad 42 filled with shock absorbing material 46 and covered with an encasement 42 made of vinyl, leather or other material strong enough to withstand substantial impact by individuals and/or livestock. The embodiment 10 is designed to fit over the top of the chute gate slider frame 18, extending slightly below the attachment area and attached at both ends of the chute frame 18. Attachment is accomplished with the use of nylon straps 30 (or other suitable material) to hold the embodiment 10 in place. Velcro strips 38 may also be used to attach the embodiment 10 to the chute frame 18. The embodiment 10 as shown 10 FIGS. 1,2 and 3 when properly mounted to the bucking chute frame 18 front and back, will greatly reduce the possibility of injury caused by the animal lunging forward and throwing the participant head first into the steel bars on the chute gate frame. It will also prevent injury when animals rare over backwards, pining the participant between the animal and the top of the chute gate.

### CROSS-REFERENCE TO RELATED APPLICATIONS

This application claims the benefit of provisional patent application Ser. No. U.S. 60/974,202, filed 2007 Sep. 21 by the present inventor.

### FEDERALLY SPONSORED RESEARCH

Not Applicable

### SEQUENCE LISTING OR PROGRAM

Not Applicable

### BACKGROUND

1. Field of Invention

The present invention relates to safety apparatus or pad that would be used on or around bucking chutes for the protection from serious injury to an individual or animal while in the bucking chute or similar containment.

2. Prior Art

In the sport of bull and or bronc riding it is well known that one of the most dangerous times is that time when the participant is in the bucking chute with the animal. It is very common to have an animal lunge forward, throwing the participant into the top gate frame or going over backwards slamming the participant against the upper part of the gate. These actions often result in serious injury to the head and neck or to the back and shoulder areas of the participant.

The sport of bull riding and bronc riding are known to be very dangerous and this is but one way to decrease the number of injuries to the individuals participating in these events.

There are times when an animal can get his legs over the top of the chute and this pad would aid in the protection of their legs and hooves. These animals are worth hundreds of thousands of dollars in some cases and need to be protected as best as possible. No prior art was found.

### SUMMARY

In accordance with one embodiment a safety pad comprises of a formed piece of foam padding covered with a protective covering that attaches to the bucking chute slider gate framework.

### DRAWINGS

### Figures

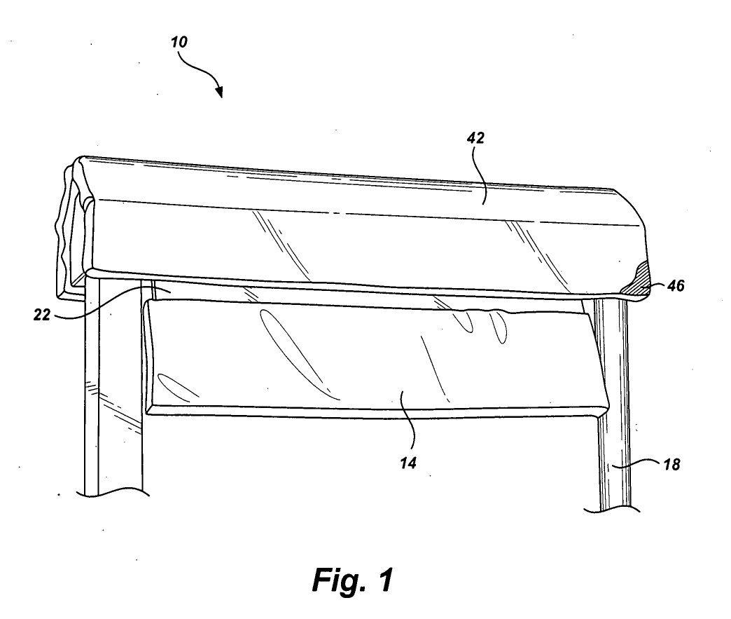

FIG. 1 shows a pad of one shape or design mounted on the chute frame with a safety extension.

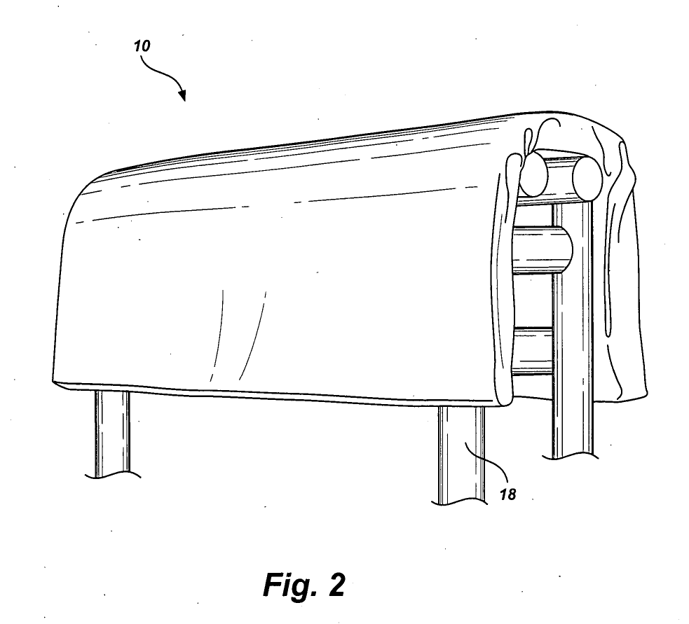

FIG. 2 shows a similar pad of a secondary shape or design mounted on a chute frame.

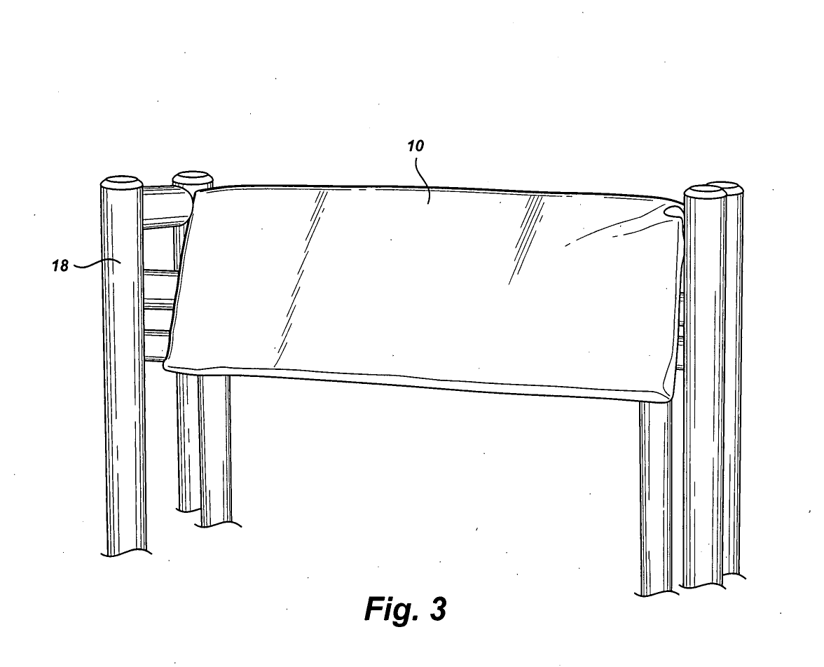

FIG. 3 shows a similar pad of a third shape or design mounted on a chute frame.

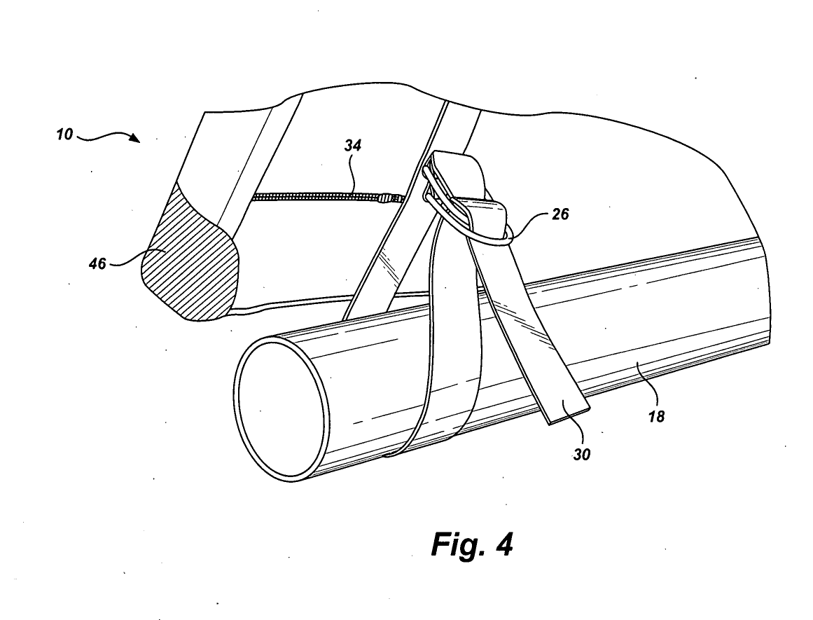

FIG. 4 shows one form of attaching the pad to the framework with the use of straps and d-rings.

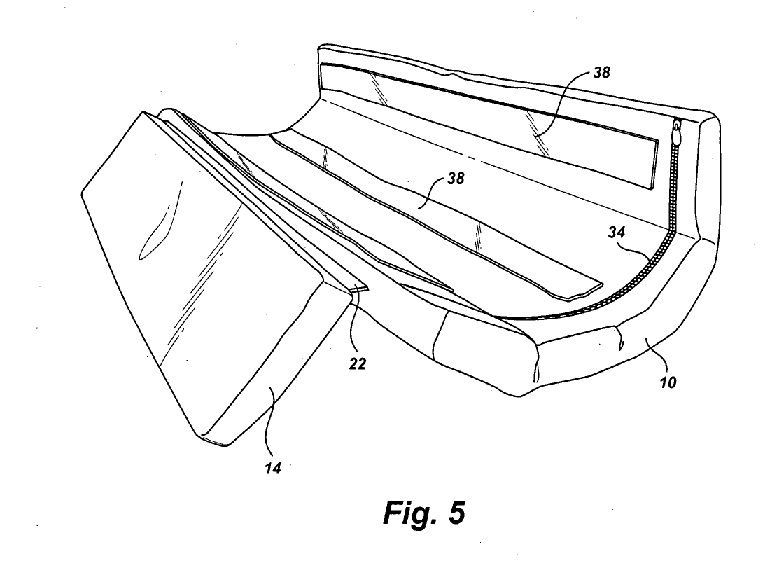

FIG. 5 shows the pad in FIG. 1 upside down revealing a second form of attachment utilizing velcro strips.

### REFERENCE NUMERALS

10 bucking chute safety pad
14 safety extension
18 chute frame
22 safety extension attachment strap
26 d-ring
30 attachment strap
34 zipper
38 velcro strips
42 encasement
46 foam insert

### DETAILED DESCRIPTION OF THE PREFERRED EMBODIMENT

It is to be understood that while a certain form of the invention is illustrated, it is not to be limited to the specific form or arrangement of parts herein described and shown. It will be apparent to those skilled in the art that various changes may be made without departing from the scope of the invention and the invention is not to be considered limited to what is shown in the drawings and described in the specifications.

We disclose a bucking chute safety pad 10 as shown in FIG. 1 mounted on top of the bucking chute frame. The safety extension 14 is extends the protected zone below what would normally be considered the danger area. The extension 14 is made of the same materials as the bucking chute safety pad 10. The preferred embodiment 10 consists of an encasement 42 made from vinyl or other suitable material to enclose the padding 46 which consists of a thick layer of high density foam or rubber.

FIGS. 2 and 3 are additional shapes for the same embodiment but designed for different bucking chute manufactures.

FIG. 4 is a bottom cutaway view showing one method of attaching the current embodiment 10 to the chute frame 18. The strap 30 and d-ring 26 arrangement is typical for all four corners of this embodiment. A zipper 34 is shown on one end of the embodiment 10 for inserting the padding 46.

FIG. 5 is a view from the underside of embodiment 10 in FIG. 1 to better illustrate the velcro strips 38 used to attach the embodiment 10 to the chute frame 18. The opposite side of the velcro strips are placed on the chute frame 18. The zipper 34 is also shown for the insertion of the padding 46.

I claim:

1. A safety-device to be used on a bucking chute or similar equipment, said device comprising of; a foam pad or pad of other suitable impact absorbing material, covering to be made of heavy vinyl, leather, or other suitable material for the purpose of enclosing the pad and protecting it from wear and damage. Nylon straps or straps of other suitable material for the purpose of attaching the pad to the frame of the bucking chute slide gate frame. Attachment straps to be designed in such a way as to allow quick attachment and removal. The use of double d-rings or other adjustable mechanisms used in conjunction with the straps would serve the purpose. Velcro strips could also be utilized as an attachment method.

2. A safety device mounted to the sliding gate framework of a typical bucking chute for the prevention of serious injury to the participant while mounting animals in the bucking chute.

3. A safety device mounted to the top and sides of the sliding gate framework to be used as a medium for advertising and promotion of safety.

4. A safety device mounted to the top and sides of the sliding gate framework to be used for the protection of the animal's legs and hooves should an animal rare or jump over the top of the slider.

5. A safety device mounted to the top and sides of the sliding gate framework for bucking chutes from all manufactures with simple dimensional and attachment changes, requiring only a different model number to be attached to each manufactures brand.
